(19) United States
(12) Patent Application Publication
(10) Pub. No.: US 2018/0331963 A1
(43) Pub. Date: Nov. 15, 2018

(54) DETERMINING DATA FLOWS TO AN INGRESS ROUTER WITH DATA FLOWS RECEIVED AT AN EGRESS ROUTER

(71) Applicant: Guavus, Inc., San Mateo, CA (US)

(72) Inventors: Mohinder Paul, Gurgaon (IN); Pragati Kumar Dhingra, New Delhi (IN); Aditya Kumar, Haryana (IN); Atul Saraf, Noida (IN)

(21) Appl. No.: 15/594,559

(22) Filed: May 12, 2017

(51) Int. Cl. H04L 12/851; H04L 12/26

(52) U.S. Cl. CPC H04L 47/2483; H04L 43/062; H04L 43/026

(57) ABSTRACT

A method for identifying an ingress router with collected IP network traffic data captured at an egress router is described. The method includes receiving, at a learning database, an ingress network traffic data flow exported from the ingress router and an ingress interface. The method then proceeds to receive, at a flow processing module, an egress network traffic data flow exported from the egress router and an egress interface. The method then enables the flow processing module to query the learning database with the egress network traffic data flow. The method determines the ingress router corresponding to the egress network traffic data flow, when the learning database matches the egress network traffic data flow with the ingress network traffic data flow.

### FIELD

The presently disclosed subject matter relates to systems and methods for determining the ingress router with data flows received at an egress router. More specifically, the system and method determines data flows at the ingress router and ingress interface with data flow received at the egress router and egress interface.

### BACKGROUND

A traffic matrix is an abstract representation of the traffic volume flowing between sets of source and destination pairs. Each element in the matrix denotes the amount of traffic between a source and destination pair. There are many variants that depend on the network layer such that sources and destinations could be routers or even whole networks. A traffic matrix is associated with the amount or rate (average, peak, P95) of data transmitted between network nodes. The more direct uses include network optimization, anomaly detection and protocol design.

Traffic matrices are utilized for a variety of network engineering goals, such as prediction of future traffic trends, network optimization, protocol design and anomaly detection. If the traffic matrix of a network is known and the operator knows the topology and routing information in the network, then an operator knows what is going on in the network. If the traffic matrix is unknown, then a network operator has little or no operational knowledge about their network.

Recently, the landscape of the Internet has changed with streaming content such as video and voice over IP (VoIP). Additionally, traffic must also be allocated for mobile devices. Furthermore, traffic matrices have many uses beyond providing business intelligence that is critical to understanding the network.

In response to the rapidly shifting landscape of network traffic demands, various traffic models have been developed. Some of these models are highly dependent on time scales such as a short time scale, e.g. seconds, or long time scales, e.g. days or weeks.

Network traffic originates from a source and is delivered to a destination (or several destinations). The traffic traverses a set of links between some set or sources and destinations. The sources and destinations often have a physical, geographic location, and so we regard their indices as spatial variables, even when they are actually logical entities, such as Autonomous Systems (AS), or cannot be directly identified as network devices, as with IP addresses.

One definition of a traffic matrix is referred to as the ingress-egress matrix. The ingress-egress traffic matrix includes ingress points, i.e. traffic going into the network, and egress points, i.e. traffic flowing out of the network. The ingress points and egress points are proxies for sources and destinations.

Network operators utilize IP network traffic matrices for planning and operational purposes. Ingress nodes, i.e. routers or switches, and egress nodes must be monitored using IP network traffic tools. IP network traffic at egress nodes may be inferred from router data and measurements of ingress traffic in conjunction with routing data; however, it is difficult to infer traffic at ingress nodes from the measurement of egress traffic.

Thus, it would be beneficial to provide a system and method capable of identifying the ingress router and ingress interface with collected IP network traffic data captured at the egress router or the egress interface.

### SUMMARY

A method for identifying an ingress router with collected IP network traffic data captured at an egress router is described. The method includes receiving, at a learning database, an ingress network traffic data flow exported from the ingress router and an ingress interface. The method then proceeds to receive, at a flow processing module, an egress network traffic data flow exported from the egress router and an egress interface. The method then enables the flow processing module to query the learning database with the egress network traffic data flow. The method determines the ingress router corresponding to the egress network traffic data flow, when the learning database matches the egress network traffic data flow with the ingress network traffic data flow.

A system for identifying an ingress router with collected IP network traffic data captured at an egress router is also described. The system includes a learning database and a flow processing module. The learning database receives an ingress network traffic data flow exported from the ingress router and an ingress interface. The learning database includes forward path information corresponding to the ingress network traffic data flow. The flow processing module receives an egress network traffic data flow exported from the egress router and an egress interface. The flow processing module queries the learning database with the egress network traffic data flow and determines the ingress router corresponding to the egress network traffic data flow, when the learning database matches the egress network traffic data flow with the ingress network traffic data flow.

In one illustrative embodiment, the ingress network traffic data flow that is exported to the learning database includes a plurality of meta data associated with a source IP address and a destination IP address. Additionally, the illustrative embodiment includes a plurality of learning databases, in which each learning database receives ingress network traffic data. The illustrative embodiment also enables the ingress routers to be communicatively coupled to the associated learning database, which stores the ingress network traffic data flow corresponding to each ingress router.

The illustrative embodiment then proceeds to query each learning database with egress network traffic data flow that includes the source IP address and the destination IP address. The ingress router corresponding to the egress network traffic data flow is determined when the source IP address and destination IP address received by the egress network traffic data flow matches the source IP address and destination IP address associated with the ingress router.

The illustrative method may also update each learning database after a pre-determined period of time. The illustrative learning database included forward path information corresponding to the ingress network traffic data flow. Additionally, the illustrative learning database matches the egress network traffic data flow with the ingress network traffic data flow with a configurable threshold that excludes inconsistent network traffic data. The illustrative learning database may also include additional database fields such as a BGP community string, port and protocol information.

### DRAWINGS

The presently disclosed subject matter will be more fully understood by reference to the following drawings, which are provided for illustrative purposes only, and not for limiting purposes.

FIG. 1 shows an illustrative system having an ingress router and an egress router

FIG. 2 shows a system capable of identifying the ingress router and ingress interface with collected IP network traffic data captured at the egress router or the egress interface.

FIG. 3 shows a method capable of identifying the ingress router and ingress interface with collected IP network traffic data captured at the egress router or the egress interface.

FIG. 4 shows an illustrative sub-system that is communicatively coupled with the one or more of components associated with system that includes an ingress router and an egress router.

### DESCRIPTION

Persons of ordinary skill in the art will realize that the following description is illustrative and not in any way limiting. Other embodiments of the claimed subject matter will readily suggest themselves to such skilled persons having the benefit of this disclosure. It shall be appreciated by those of ordinary skill in the art that the systems and methods described herein may vary as to configuration and as to details. Additionally, the methods may vary as to details, order of the actions, or other variations without departing from the illustrative methods disclosed herein.

Network traffic originates from a source and is delivered to a destination (or several destinations). The traffic traverses a set of links between some set or sources and destinations. The links connected these find the topology of the network, and the path chosen by traffic flows determine the routing. Traffic may be split across multiple paths by load balancing, or may keep to a single path. Often, sources and destinations are identified with network devices such as switches or routers, but they can also refer to a location in a logical pace attached to the network for instance IP addresses or prefix blocks.

The sources and destinations often have a physical, geographic location, and so we regard their indices as spatial variables, even when they are actually logical entities, such as Autonomous Systems (AS), or cannot be directly identified as network devices, as with IP addresses.

There are two definitions of traffic matrices, namely, the origin-destination matrix and the ingress-egress matrix. The origin-destination matrix measures traffic from the true source to destination, i.e. the point that generates a packet to the point that receives the packet.

With respect to the ingress-egress traffic matrix, any single network operator sees only a small proportion of the origin-destination matrix, the origin-destination traffic matrix is unknown and immeasurable by a single operator. Instead, many operators find that using their edge routers or edge links as sources and destinations results in a local traffic matrix. The ingress-egress traffic matrix includes ingress points, i.e. traffic going into the network, and egress points, i.e. traffic flowing out of the network. The ingress points and egress points are proxies for sources and destinations. A single ingress node or egress node may denote a router, a collection of physically co-located routers referred to as a Point-of-Presence (PoP).

Ingress-egress traffic matrices can be obtained a number of ways. The can be formed from OD traffic matrix simply by mapping IP prefixes to ingress or egress locations in the network, but this assumes knowledge of all flows traversing the ingress or egress nodes. Traffic at egress nodes may be inferred from router data and measurements of ingress traffic. However, it is difficult to infer traffic at ingress nodes from measurement of egress traffic.

Collecting IP network traffic as it enters or exits an interface can be performed by a variety of IP network traffic tools. One illustrative IP network traffic tool is NetFlow, which is associated with Cisco routers. An illustrative flow monitoring setup for a IP network traffic tool includes three main components, namely, a flow exporter, a flow collection and an analysis application. The flow collector aggregates packets into flows and exports flow records toward one or more flow collectors. The flow collector is responsible for reception, storage and pre-processing of flow data received from the flow exported. The analysis application analyzes received flow data, e.g. in the context of intrusion detection or traffic profiling.

NetFlow is a system providing the ability to collect IP network traffic as it enters or exits a given interface. NetFlow allows a network administrator to determine the source and destination of traffic, and a class of service associated with the traffic. NetFlow performs by associating any unidirectional sequence of data packets that all share seven values: ingress interface, source IP address, destination IP address, IP protocol, source port for UDP or TCP (all other protocols return a 0 value), destination port for UDP or TCP and type and code for IMCP (all other protocols return a 0 value), and IP type of service. NetFlow has three components: a flow exporter, a flow collector, and an analysis application. The flow exporter aggregates packets into flows, and exports flow records towards one or more flow collectors. Flow collectors are responsible for reception, storage, and pre-processing of flow data received from a flow exporter. An analysis application analyzes received flow data in the context of intrusion detection or traffic profiling.

In operation, routers and switches that support IP network traffic tools such a NetFlow collect IP traffic statistics on all interfaces where IP network traffic tools are enabled. The IP network traffic tools export these statistics to the flow collector, which is typically a server that performs the traffic analysis.

By way of example and not of limitation, the network flow may be defined as a unidirectional sequence of packet that share values such as an ingress interface, a source IP address, a destination IP address, an IP protocol, a source pot for UDP or TCP, a destination port for UDP or TCP and an IP Type of Server.

The Border Gateway Protocol (BGP) is a standardized exterior gateway protocol designed to exchange routing and reachability information among autonomous systems (AS) on the Internet. The BGP is often classified as a path vector protocol or as a distance-vector routing protocol. The BGP makes routing decision based on paths, network policies or rule sets configured by a network administrator. The BGP is involved in many core routing functions.

The BGP is a standard for Internet routing used by most Internet Service Providers (ISPs) to establish routing between one another. Very large private IP networks used BGP internally. An internal BGP occurs when BGP runs between two peers in the same autonomous system (AS) and an external BGP runs between different autonomous systems.

The external BGP may also be referred to as an Exterior Gateway Protocol (EGP), which exchanges routing and reachability information among autonomous systems (administratively and/or physically distinct networks). The BGP uses the routing and reachability information to make routing decisions based on paths, network policies, and/or rule-sets configured by a network administrator.

The internal BGP may also be referring to as an Interior Gateway Protocols (IGP), such as an Interior Border Gateway Protocol (iBGP), which are used for routing within an autonomous system. IGPs perform their routing function by exchanging routing information between gateways (commonly routers) within the autonomous system (i.e., system of corporate local area networks).

Network operators utilize IP network traffic matrices for planning and operational purposes. For purposes of the illustrative embodiments presented below, the interactions between the illustrative ingress nodes, i.e. routers or switches, and egress nodes must be monitored using IP network traffic tools such as NetFlow. Typically network operation support NetFlow sampling and flow export on all interfaces on all or most routers in either the ingress direction or the egress direction or both.

As used herein the term “ingress” generally relates to traffic received or “in” traffic as defined from the network operator perspective. The term “egress” refers to transmitted traffic or “out” traffic as defined from the network operator perspective.

As previously stated, traffic at egress nodes may be inferred from routing data and measurements of ingress traffic, however, it is difficult to infer traffic at ingress nodes from the measurement of egress traffic. More specifically, the challenge is to identify the ingress router and ingress interface when NetFlow data has been captured at the egress router.

Generally, BGP can be used in the forwarding direction if the NetFlow data has been captured at the ingress router. However, in the reverse direction, using only BGP leads to incorrect router determination because of asymmetric routing in the network. The incorrectness may be up to 50% and hence obviates the use of the BGP forwarding table to solve this problem.

Asymmetric routing in general is a normal, but unwanted situation in an ISP network. By way of example and not of limitations, asymmetric routing is a situation where packets flowing to TCP connections flow through different routes when traveling different directions. For example, Host A and Host B located on different continents are communicating through a TCP connection. Segments sent from Host A to Host B reach the destination through a Sprint link, but segments sent from Host B to Host A reach the destination through a MCI link.

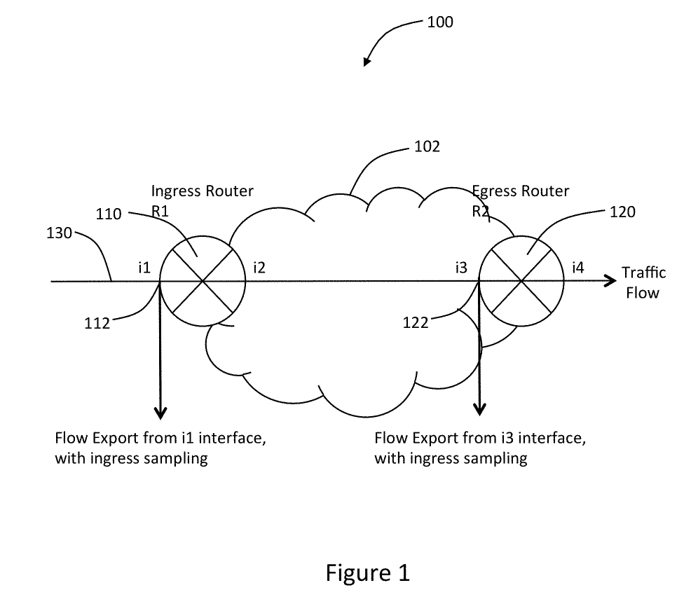

Referring now to FIG. 1, there is shown an illustrative system 100 for an ISP 102 having an ingress router and egress router. The illustrative ISP 102 includes two routers, 110 and 120, differentiated as ingress router 110 and egress router 120. Illustrative router 110 and illustrative router 120 both transfer incoming and outgoing data flows, and are therefore capable of being either the ingress router or the egress router for a given data flow. An ingress interface 112 is associated with ingress router 110. Similarly, an egress interface 122 is associated with egress router 120. An illustrative data traffic flow arrow 130 represents a flow of data traversing the ISP 100 from the ingress interface 112 at the ingress router 110, through the ISP 100, to the egress interface 122 at the egress router 120.

An interface is a system's software and/or hardware that interfaces between two pieces of equipment or protocol layers in a computer network. The interfaces each have a network address.

As previously stated, the challenge is to infer traffic at ingress nodes from the measurement of egress traffic. In the illustrative embodiment presented in FIG. 1, the end-to-end traffic matrices for ingress router 110 (R1) and ingress interface 112 (i1) are challenging to determine using the NetFlow record from egress interface 122 (i3).

For example, if BGP routing table is used at egress router 120 (R2), and the source IP is treated as a destination IP, the lookup table will yield an incorrect result because of asymmetric routing. Additionally, the packet flows from ingress router 110 (R1) and egress router 120 (R2) are challenging to correlate because they are very compute intensive, even for small networks.

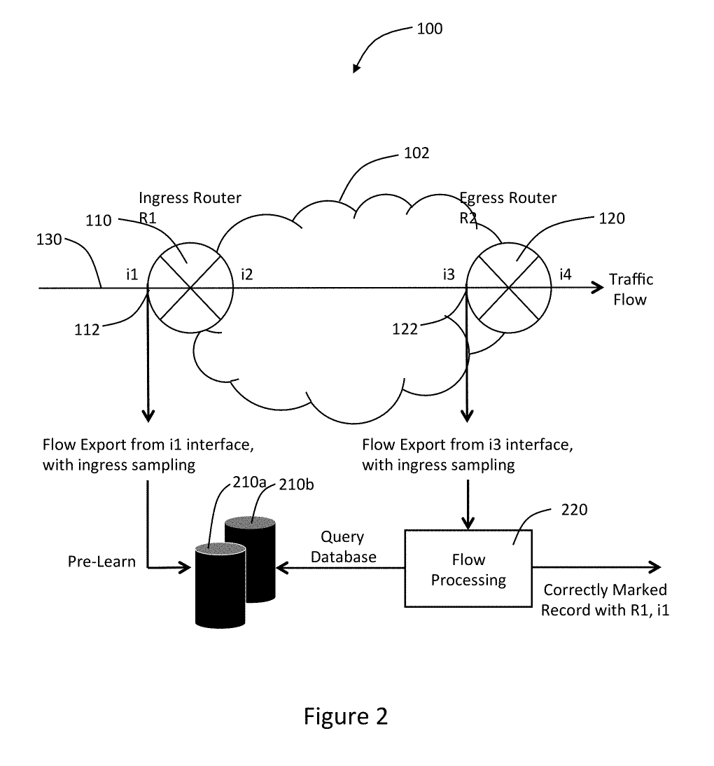

Referring to FIG. 2 there is shown a system capable of identifying the ingress router and ingress interface with collected IP network traffic data captured at the egress router or the egress interface. In the illustrative embodiment, the identification of the ingress router or “source” router is determined using BGP, NetFlow, a learning database and a flow processing module. The goal of the system and method is to annotate every flow record received by the ingress router 110, the ingress interface 112, the egress router 120 and the egress interface 122.

Network traffic data flow records captured at ingress router 110 and BGP can be used to determine network traffic data flow records in egress router 120, when the network traffic data flow from in the forward path from the ingress router 110 to the egress router 120. However, for a network traffic data flow reported at egress router 120, BGP cannot be used in the reverse path because the forward path is typically different from the reverse path in the network.

The illustrative system 200 determines the ingress router 110 and ingress interface 112 for network traffic data flows received at egress router 120 and egress interface 122. The illustrative system 200 includes one or more learning databases 210a and 210b and a flow processing module 220.

Each learning database 210 receives ingress network traffic data flow exported from each ingress router and ingress interface. The learning database 210 includes forward path information corresponding to the ingress network traffic data flow. The flow processing module 220 receives an egress network traffic data flow exported from the egress router 120 and an egress interface 122.

By way of example and not of limitation, the flow processing module 220 queries the illustrative learning database 210a with the egress network traffic data flow and determines the ingress router 110 corresponding to the egress network traffic data flow, when the learning database 210a matches a portion of the egress network traffic data flow with a similar portion of the ingress network traffic data flow.

In one illustrative embodiment, the ingress network traffic data flow that is exported to the learning database 210a includes a plurality of meta data associated with a source IP address and a destination IP address.

In another illustrative embodiment, a plurality of learning databases (not shown) are communicatively coupled to a respective plurality of ingress routers (not shown). Thus, each separate learning database receives ingress network traffic data from a corresponding ingress router as shown in FIG. 2. With respect to each of the plurality of ingress routers, each associated learning database stores the corresponding ingress network traffic data flow corresponding for each ingress router.

In operation, the flow processing module 220 proceeds to query each learning database 210a or 210b with egress network traffic data flow that includes the illustrative source IP address and the destination IP address. By way of example and not of limitation, the ingress router 110 corresponding to the egress network traffic data flow is determined when the source IP address and destination IP address received by the egress network traffic data flow matches the source IP address and destination IP address associated with the ingress router 110.

With respect to the learning databases 210a and 210b, the learning databases 210a and 210b may be updated after a pre-determined period of time. Generally, the learning databases 210a and 210b include forward path information corresponding to the ingress network traffic data flow. Additionally, the illustrative learning database 210a and 210b matches the egress network traffic data flow with the ingress network traffic data flow with a configurable threshold that excludes inconsistent network traffic data. The illustrative learning database 210a and 210b may also include additional database fields such as a BGP community string, port and protocol information.

More specifically, an illustrative first learning database 210a processes the network traffic data flow records at ingress router 110 by collecting meta data that “learns” the source and destination combinations. Additionally, the illustrative first database 210a associates the collected meta data with the ingress interface 112. The illustrative first database 210a is presumed to have correct data because the first database 210a is collecting BGP data acquired in the forward direction.

By way of example and not of limitation, the flow processing module 220 receives NetFlow data from egress router 120. The flow processing module 220 then proceeds to query one or more of the illustrative databases 210. In the illustrative embodiment, the database 210a is queried to identify the appropriate ingress router and ingress interface.

Alternatively, a correlation may be made regarding network traffic data flows between ingress router 110 and egress router 120. However, the process of generating the correlation requires significantly higher compute cycles than collecting meta data at the ingress router and storing the collected meta data in illustrative database 210a. Additionally, querying the databases 210 also requires less compute cycles that trying to correlate network traffic data flows between ingress router 110 and egress router 120.

For flows reported at egress router 120, in which the reverse path to the ingress router 110 varies, the flow from the ingress router 110 and ingress interface 112 can be found with a learning database 210a that may be accessed and controlled with a learning module and an annotation module. The illustrative learning module receives forward direction flows that are used to “learn” the information about the source IP, destination IP and ingress router interface; and this learnt information is put into the learning database 210.

The annotation module includes an annotation process, in which the plurality of learning databases 210 across all routers are used to determine the right ingress router and ingress interface. Thus, the plurality of learning databases 210 are searched for where the same source IP and destination IP pair are seen in the network in the most current database.

Changing forwarding tables is necessary due to changing network environment. Therefore, the plurality of learning databases 210 cannot be static. The plurality of learning databases 210 have to be updated continuously. By way of example and not of limitation, the updating process is performed in batches of 15 minutes to 1 hour.

In operation, the annotation process must use the learning database for the corresponding time interval, T0. Sometimes the learning database 210 may not be able to report a result. When the database does not report a result, the previous database corresponding to a previous corresponding time period, e.g. T0-1 period, may be used. In case no result is still seen with the previous learning database, the ingress router 110 and ingress interface 112 may be either marked as unknown, or the BGP reverse direction can be used to find the ingress router, depending on the user and the use case.

In some cases, learning databases 210 at multiple routers may yield a positive result. This is mainly due to multi-homed prefixes. These cases can be resolved by storing additional information in the learning database 210. By way of example and not of limitation, the additional information in the database may include ASN forward path information so that the BGP forward paths must match exactly.

In another illustrative embodiment, the additional information in the learning database 210 may ignore database records (and hence those router interfaces) that have less than a configurable threshold, e.g. say 5%, of bytes reported across all database records, which helps exclude minor routing glitches and error cases.

In yet another illustrative embodiment, the additional information in the learning database 210 includes additional fields from flow data to ensure correction annotations, e.g. BGP community strings, port and protocol information etc.

FIG. 2 show a simplified version of the learning database 210, based on ingress data feeds. However, the learning database 210 may also be communicatively coupled to an egress router 120 or bi-directional sampled interfaces. The basic pre-requisite for generating and accessing the learning database 210 is that only accurate paths such as forward direction paths are utilized to generate the learning database 210.

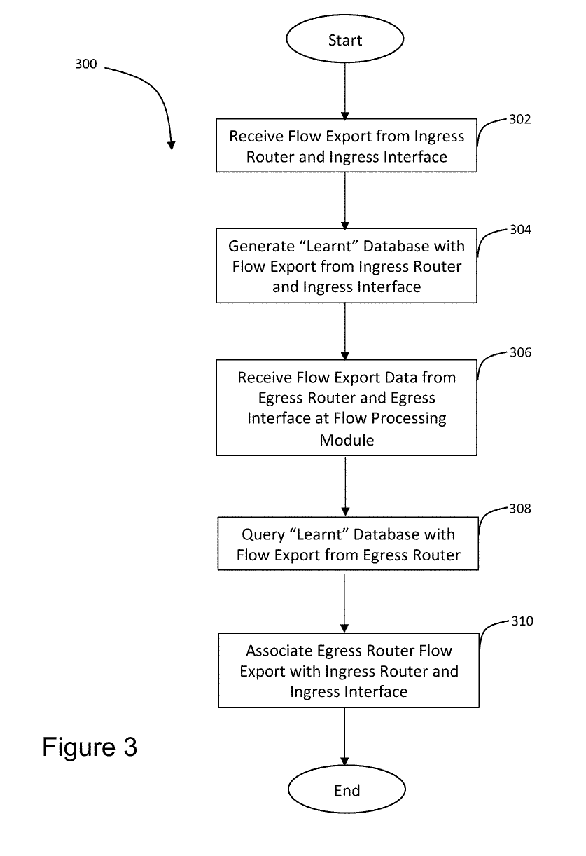

Referring to FIG. 3, there is shown a method 300 capable of identifying the ingress router and ingress interface with collected IP network traffic data captured at the egress router or the egress interface. The goal of the method is to annotate every flow record received by the ingress router 110, the ingress interface 112, the egress router 120 and the egress interface 122.

The method is initiated at block 302 where network traffic data flow is exported from the ingress router 110 and the ingress interface 112. At block 304, a learning database 210 is generated with flow export from the ingress router and the ingress interface. At block 306, the flow processing module 220 receives flow export data from the egress router 120 and egress interface 122.

At block 308, the learning database 210 is queried with flow export from the egress router 120. At block 310, the method determines the ingress router corresponding to the egress network traffic data flow, when the learning database matches the egress network traffic data flow with the ingress network traffic data flow.

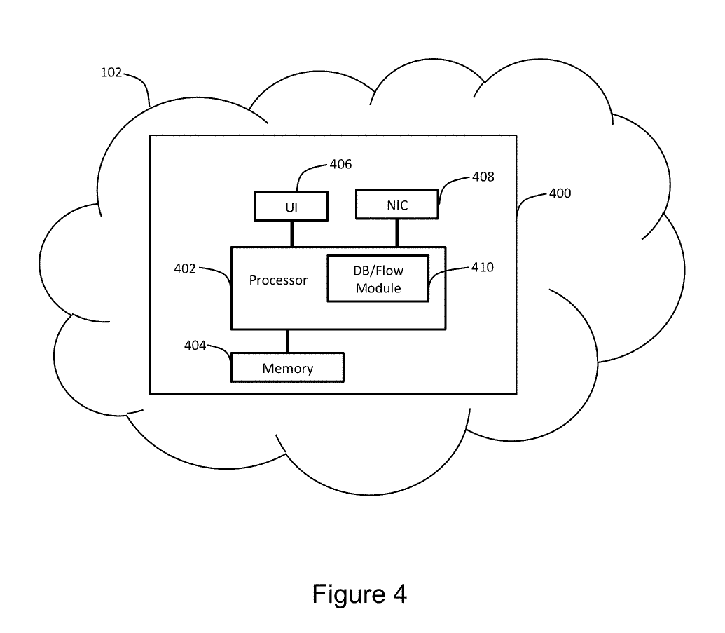

Referring to FIG. 4, there is shown an illustrative sub-system 400 that is communicatively coupled with the one or more of components associated with system 200. The sub-system 400 is configured to interface with the database 210 and flow processing module 220.

More specifically, the sub-system 400 includes at least one processor 402 that is communicatively coupled to a memory 404. Multiple processors may also perform the operations described. Additionally, the illustrative sub-system communicates with a user interface (UI) 406 that receives inputs that are processed by illustrative processor 402. The sub-system 400 may also be networked to other sub-systems with an illustrative network interface card (NIC) 408 or other communications pathways, e.g. a serial bus. A flow processing module and/or a database module is provided in illustrative software module 410.

The sub-system 400 may operate in centralized system architecture, distributed system architecture or any combination thereof. Additionally, the operations performed by the sub-system 400 may be performed by any network asset that is securely accessible by the ISP 102.

The systems and methods presented herein describe a system and method capable of identifying the ingress router and ingress interface with collected IP network traffic data captured at the egress router or the egress interface. The system and method includes a database and a flow processing module. The database that captures flow records from an ingress router/interface. The flow processing module captures flow records from an egress router/interface and queries the database or databases to identify the corresponding ingress router/interface.

It is to be understood that the detailed description of illustrative embodiments is provided for illustrative purposes. The scope of the claims is not limited to these specific embodiments or examples. Therefore, various process limitations, elements, details, and uses can differ from those just described, or be expanded on or implemented using technologies not yet commercially viable, and yet still be within the inventive concepts of the present disclosure. The scope of the invention is determined by the following claims and their legal equivalents.

What is claimed is:

1. A method for identifying an ingress router with collected IP network traffic data captured at an egress router, the method comprising:
receiving, at a learning database, an ingress network traffic data flow exported from the ingress router and an ingress interface;
receiving, at a flow processing module, an egress network traffic data flow exported from the egress router and an egress interface;
enabling the flow processing module to query the learning database with the egress network traffic data flow; and
determining the ingress router corresponding to the egress network traffic data flow, when the learning database matches the egress network traffic data flow with the ingress network traffic data flow.

2. The method of claim 1 wherein the ingress network traffic data flow that is exported to the learning database includes a plurality of meta data associated with a source IP address and a destination IP address.

3. The method of claim 2 further comprising,
providing a plurality of learning databases, in which each learning database receives ingress network traffic data,
enabling a plurality of ingress routers to be communicatively coupled to the associated learning database, which stores the ingress network traffic data flow corresponding to each ingress router.

4. The method of claim 3 further comprising,
querying each learning database with egress network traffic data flow that includes the source IP address and the destination IP address, and
determining the ingress router corresponding to the egress network traffic data flow, when the source IP address and destination IP address received by the egress network traffic data flow matches the source IP address and destination IP address associated with the ingress router.

5. The method of claim 4 further comprising updating each learning database after a pre-determined period of time.

6. The method of claim 1 wherein the learning database includes a plurality of forward path information corresponding to the ingress network traffic data flow.

7. The method of claim 1 wherein the learning database matches the egress network traffic data flow with the ingress network traffic data flow with a configurable threshold that excludes inconsistent network traffic data.

8. The method of claim 1 wherein the learning database further includes a plurality of database fields associated with the ingress network traffic data that include at least one of a BGP community string, port and protocol information.

9. A method for identifying an ingress router with collected IP network traffic data captured at an egress router, the method comprising:
providing a plurality of learning databases, in which each learning database receives ingress network traffic data;
enabling a plurality of ingress routers to be communicatively coupled to the associated learning database, which stores the ingress network traffic data flow corresponding to each ingress router;
receiving, at a learning database, an ingress network traffic data flow exported from the ingress router and an ingress interface, wherein the ingress network traffic data include a plurality of forward path information having meta data associated with a source IP address and a destination IP address;
receiving, at a flow processing module, an egress network traffic data flow exported from the egress router and an egress interface;
enabling the flow processing module to query the learning database with the egress network traffic data flow; and
determining the ingress router corresponding to the egress network traffic data flow, when the learning database matches the egress network traffic data flow with the ingress network traffic data flow.

10. The method of claim 9 further comprising,
querying each learning database with egress network traffic data flow that includes the source IP address and the destination IP address, and
determining the ingress router corresponding to the egress network traffic data flow, when the source IP address and destination IP address received by the egress network traffic data flow matches the source IP address and destination IP address associated with the ingress router.

11. The method of claim 9 further comprising updating each learning database after a pre-determined period of time.

12. The method of claim 9 wherein the learning database matches the egress network traffic data flow with the ingress network traffic data flow with a configurable threshold that excludes inconsistent network traffic data.

13. The method of claim 9 wherein the learning database further includes a plurality of database fields associated with the ingress network traffic data that include at least one of a BGP community string, port and protocol information.

14. A system for identifying an ingress router with collected IP network traffic data captured at an egress router, the system comprising:
a learning database that receives an ingress network traffic data flow exported from the ingress router and an ingress interface, wherein the learning database includes a plurality of forward path information corresponding to the ingress network traffic data flow;
a flow processing module that receives an egress network traffic data flow exported from the egress router and an egress interface; and
wherein the flow processing module queries the learning database with the egress network traffic data flow and determines the ingress router corresponding to the egress network traffic data flow, when the learning database matches the egress network traffic data flow with the ingress network traffic data flow.

15. The system of claim 14 wherein the ingress network traffic data flow that is exported to the learning database includes a plurality of meta data associated with a source IP address and a destination IP address.

16. The system of claim 14 further comprising,
a plurality of learning databases, in which each learning database receives ingress network traffic data,
a plurality of ingress routers communicatively coupled to the associated learning database, which stores the ingress network traffic data flow corresponding to each ingress router.

17. The system of claim 16 further comprising,
querying each learning database with egress network traffic data flow that includes the source IP address and the destination IP address, and
determining the ingress router corresponding to the egress network traffic data flow, when the source IP address and destination IP address received by the egress network traffic data flow matches the source IP address and destination IP address associated with the ingress router.

18. The system of claim 14 further comprising updating each learning database after a pre-determined period of time.

19. The system of claim 14 wherein the learning database matches the egress network traffic data flow with the ingress network traffic data flow with a configurable threshold that excludes inconsistent network traffic data.

20. The system of claim 14 wherein the learning database further includes a plurality of database fields associated with the ingress network traffic data that include at least one of a BGP community string, port and protocol information.
